(19) United States
(12) Patent Application Publication
(10) Pub. No.: US 2014/0351724 A1
(43) Pub. Date: Nov. 27, 2014

(54) METHOD AND APPARATUS FOR REPOSITIONING OF VISUAL ITEMS

(71) Applicant: Samsung Electronics Co., Ltd., Gyeonggi-do (KR)

(72) Inventors: Seungnyun KIM, Incheon (KR); Haedong LEE, Daegu (KR); Taejin MOON, Daegu (KR)

(73) Assignee: Samsung Electronics Co., Ltd., Gyeonggi-do (KR)

(21) Appl. No.: 14/285,948

(22) Filed: May 23, 2014

(30) Foreign Application Priority Data
May 27, 2013 (KR) 10-2013-0059526

(51) Int. Cl. G06F 3/0488; G06F 3/0481

(52) U.S. Cl. CPC G06F 3/04883; G06F 3/04817
USPC 715/765

(57) ABSTRACT

A method is provided for operating an electronic device comprising: displaying a plurality of visual items on a screen of the electronic device; detecting a first gesture received at the electronic device; detecting whether the first gesture corresponds to a request for repositioning the plurality of visual items; and when the first gesture corresponds to the request for repositioning the plurality of visual items, repositioning the plurality of visual items based on a direction of the first gesture.

### CLAIM OF PRIORITY

This application claims priority from and the benefit under 35 U.S.C. §119(a) of Korean Patent Application No. 10-2013-0059526, filed on May 27, 2013, which is hereby incorporated by reference for all purposes as if fully set forth herein.

### BACKGROUND

1. Field of the disclosure

The present disclosure relates to electronic devices, and more particularly to a method and apparatus for repositioning of visual items.

2. Description of the Prior Art

Ordinarily, users of portable terminals select displayed icon using their thumbs. When a user controls a portable terminal with the thumb of the hand that is used to hold the terminal, the portable terminal is in danger of being dropped. Also, the user may be inconvenienced because of the icon being difficult to reach with the user's thumb. Accordingly, the need exists for new user interfaces that permit new ways of interacting with icons that are part of those interfaces.

### SUMMARY

The present disclosure addresses this need. According to one aspect of the disclosure, a method is provided for operating an electronic device comprising: displaying a plurality of visual items on a screen of the electronic device; detecting a first gesture received at the electronic device; detecting whether the first gesture corresponds to a request for repositioning the plurality of visual items; and when the first gesture corresponds to the request for repositioning the plurality of visual items, repositioning the plurality of visual items based on a direction of the first gesture.

According to another aspect of the disclosure, an electronic device is provided comprising: a display panel; a touch panel; and a controller configured to: display a plurality of visual items on the display panel; detect a first gesture received at the touch panel; detecting whether the first gesture corresponds to a request for repositioning the plurality of visual items; and when the first gesture corresponds to the request for repositioning the plurality of visual items, repositioning the plurality of visual items based on a direction of the first gesture.

According to yet another aspect of A portable terminal is provided comprising: a display panel; a touch panel; and a controller configured to: display a plurality of icons on the display panel; detect a first gesture received at the touch panel; detecting whether the first gesture corresponds to a request for repositioning the plurality of icons; and when the first gesture corresponds to the request for repositioning the plurality of icons, repositioning the plurality of icons based on a direction of the first gesture.

### BRIEF DESCRIPTION OF THE DRAWINGS

The above features and advantages of the present disclosure will be more apparent from the following detailed description in conjunction with the accompanying drawings, in which:

FIG. 1 is a block diagram illustrating an example of a portable terminal according to an aspect of the present disclosure;

FIG. 2 is a flowchart of an example of a process for repositioning of visual items, according to aspects of the disclosure;

FIG. 3A, FIG. 3B, FIG. 3C and FIG. 3D are diagrams illustrating an example of the operation of the process of FIG. 2, according to aspects of the disclosure;

FIG. 4 is a flowchart of another example of a process for repositioning of visual items, according to aspects of the disclosure;

FIG. 5A, FIG. 5B, FIG. 5C, FIG. 5D, FIG. 5E, FIG. 5F, FIG. 5G and FIG. 5H are diagrams illustrating an example of the process of FIG. 4, according to aspects of the present disclosure;

FIG. 6 is a flowchart of yet another example of a process for repositioning of visual items, according to aspects of the disclosure;

FIG. 7 is a flowchart of yet another example of a process for repositioning of visual items, according to aspects of the disclosure; and

FIG. 8A, FIG. 8B, FIG. 8C, FIG. 8D, FIG. 8E and FIG. 8F are diagrams illustrating an example of the operation of the process of FIG. 7, according to aspects of the disclosure.

### DETAILED DESCRIPTION

Hereinafter, aspects of the present disclosure will be described in detail with reference to the accompanying drawings. It should be noted that the same elements will be designated by the same reference numerals although they are shown in different drawings. Further, detailed descriptions related to well-known functions or configurations capable of making subject matters of the present disclosure unnecessarily obscure will be omitted.

Meanwhile, exemplary aspects of the present disclosure shown and described in this specification and the drawings correspond to specific examples presented in order to easily explain technical contents of the present disclosure, and to help comprehension of the present disclosure, but are not intended to limit the scope of the present disclosure. It is obvious to those skilled in the art to which the present disclosure pertains that other modified aspects on the basis of the spirit of the present disclosure besides the aspects disclosed herein can be carried out.

In the present disclosure, a screen is a menu screen in which icons corresponding applications are arranged in 4 rows and 4 columns or 5 rows and 5 columns, in a grid. The number of rows and columns in the screen may not be limited thereto. Also, the screen may display icons corresponding to applications, items, files, images, thumbnails, or the like. The screen may be formed of one or more screens including the above described arrangement. Also, the screen may be a menu screen which is divided into two sections based on a reference line. The screen may be a menu screen that is divided into quadrant sections based on a reference point.

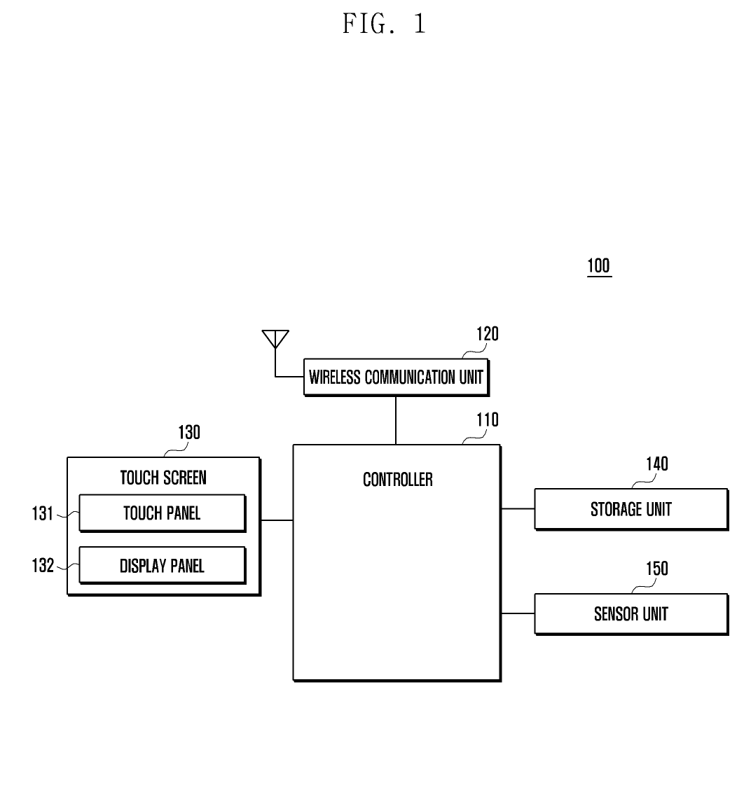

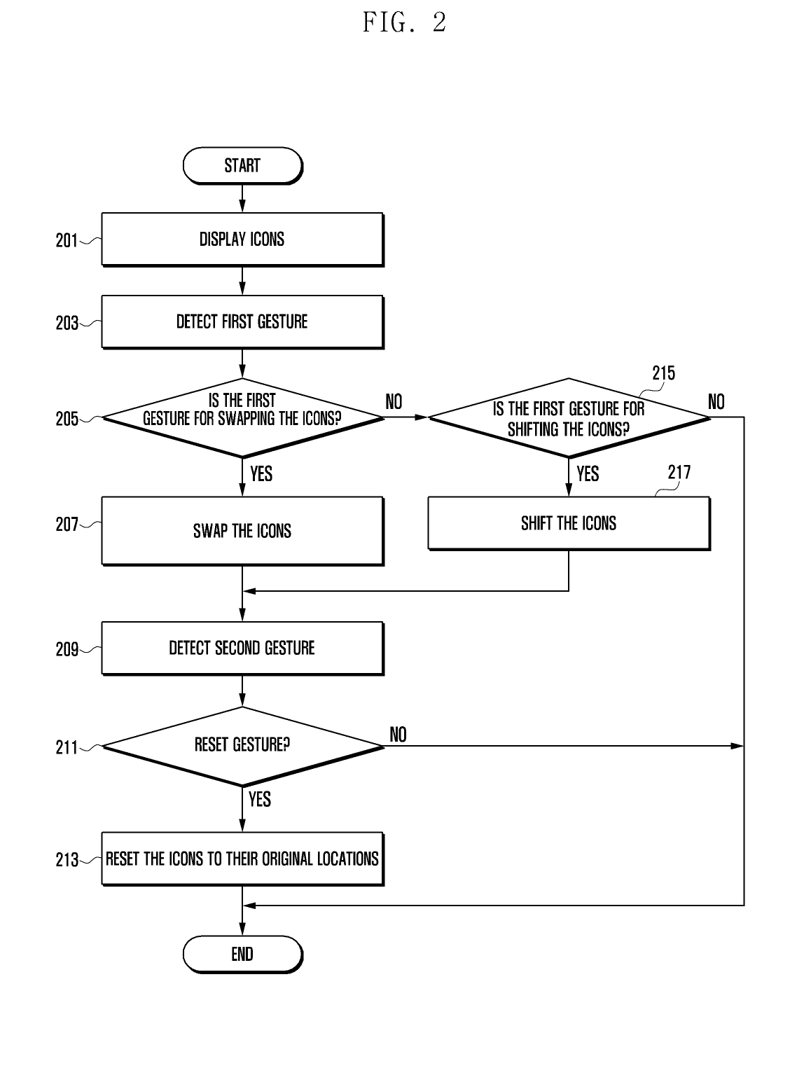

FIG. 1 is a block diagram illustrating an example of a portable terminal according to an aspect of the present disclosure.

Referring to FIG. 1, a portable terminal 100 according to the present disclosure may be configured to include a controller 110, a wireless communication unit 120, a touch screen 130, a storage unit 140, and a sensor unit 150. According to aspects of the disclosure, the portable terminal 100 may include a smartphone, a laptop, a tablet and/or any other suitable type of portable terminal.

The controller 110 controls overall operations of the portable terminal 100 and a signal flow among the internal structures of the portable terminal 100, performs a function of processing data, and supplies power to the structures from the battery. The controller 110 may include processing circuitry, such as a Central Processing Unit (CPU), and/or Graphic Processing Unit (GPU), and/or any other suitable type of processing circuitry. Meanwhile, as is well known, the CPU is a core control unit of a computer system which performs calculations and comparisons of data, the interpretation and execution of instructions, and the like. The GPU is a graphic control unit which performs calculations and comparisons of graphic-related data, and the interpretation and execution of instructions, and the like. Each of the CPU and the GPU may be integrated into one package in which two or more independent cores (for example, quad-core) form a single integrated circuit. Alternatively, the CPU and the GPU may be integrated into one chip (System on Chip (SoC)). Further, the CPU and the GPU may be packaged as a multi-layer structure. The CPU and the GPU may be referred to as an “Application Processor (AP)”.

In operation, the controller 110 may detect a direction and a length of a user input. For example, the user input may be a drag and the controller 110 may detect the drag, so as to reposition icons on a menu screen based on the direction of the drag. Additionally or alternatively, the controller 110 may detect the length of the drag, so as to reposition icons based on the length of the drag.

The wireless communication unit 120 performs a voice call, a video call, or data communication with an external device over a network under a control of the controller 110. The wireless communication unit 120 may include a wireless frequency transmitting unit that up-converts and amplifies a frequency of a transmitted signal, and a wireless frequency receiving unit that low noise amplifies and down-converts a frequency of a received signal. The wireless communication unit 120 may include a mobile communication module, for example, a third-generation (3G) mobile communication module, a 3.5-Generation mobile communication module, a 4-Generation mobile communication module, or the like, a digital broadcasting module, for example, a DMB module, and a short-range communication module, for example, a WiFi module, a Bluetooth module or a Near Field Communication (NFC) module.

The touch screen 130 may be configured to include the touch panel 131 and a display panel 132.

The display panel 132 may display a content on a screen (a screen on which at least one image is shown), under a control of the controller 110. That is, when the controller 110 processes (for example, decode, resize) a content for storage, the display panel 132 may convert the content stored in a buffer into an analog signal for display on a screen. When power is provided to the display panel 132, the display panel 132 may display a lock image (referred to as a login image), on a screen. In the state that the lock image is displayed, when unlock information (that is, a password) is detected, the controller 110 executes unlocking. That is, the display panel 132 displays another image as opposed to the lock image, under a control of the controller 110. Here, the unlock information corresponds to a text (for example, 1234) which a user inputs into the portable terminal 100 by using a keypad or a key input unit displayed on the screen, a direction of a user gesture or a trace of a user gesture (for example, a drag) for the display panel 132, or voice data of a user provided to the portable terminal 100 through a microphone (MIC). Examples of the other image may include a home image, an application execution image, a keypad, a menu screen, or the like. The home image includes a background image and a plurality of icons displayed on the background image. Here, each icon indicates an application or a content (for example, an image file, a video file, a voice recording file, a document, a message and the like).When a user selects, for example, an application icon (for example, taps on an icon) from among icons, the controller 110 executes the corresponding app (for example, an app that provides an SNS), and controls the display panel 132 to display the execution image. The display panel 132 may display one of the images, for example, an application execution image, as a background, and may display another image, for example, a key pad, to overlap the background, as a foreground, based on a control of the controller 110. Also, the display panel 132 may display a first image on a first area, and display a second image on a second area, based on a control of the controller 110. The display panel 132 may be formed of a Liquid Crystal Display (LCD), OLED (Organic Light Emitted Diode), an Active Matrix Organic Light Emitted Diode (AMOLED), or a flexible display.

The touch panel 131 is placed on the display panel 132. Particularly, the touch panel 131 is embodied as an add-on type touch panel which is placed on the screen of the display panel 132, or an on-cell type or in-cell type touch panel which is inserted in the display panel 132. The touch panel 131 generates analog signals (for example, a touch event) in response to a user gesture thereon, and converts the analog signals into digital signals to transmit the digital signals to the controller 110. Here, the touch event includes touch coordinates (x, y). For example, a controller of the touch panel 131 determines representative coordinates among plural touch coordinates, and transmits the determined touch coordinates to the controller 110. Such a control may be performed by the controller 110. The touch coordinates may be based on a pixel unit. For example, when a resolution of a screen is 640 (the number of horizontal pixels) *480 (the number of vertical pixels), coordinates of X axis are (0, 640), and coordinates of Y axis are (0, 480). When the touch coordinates are received from the touch panel 111, the controller 110 determines that a touch input instrument (for example, a finger or a pen) touches the touch panel 131. Further, when the touch coordinates are not received from the touch panel 131, the controller 170 determines that a touch of the touch input instrument is removed. Further, when touch coordinates are changed, for example, from coordinates (x0, y0) to coordinates (x1, x2) and the variation of the touch coordinates (for example, D(D²=(x0−x1)²+(y0−y1)²)) exceeds a predetermined “movement threshold (for example, 1 mm),” the controller 110 determines that the touch input instrument moves. The controller 110 calculates the variation (dx, dy) of a position of the touch and a movement rate of the touch input instrument in response to the movement of the touch input instrument. The controller 110 determines a user gesture to be one of a touch, a multi-touch, a tap, a double-tap, a long-tap, a tap-and-touch, a drag, a flick, a press, a pinch-in, a pinch-out and the like, based on touch coordinates, whether a touch of a touch input instrument is removed, whether a touch input instrument moves, the variation of a position of a touch input instrument, a movement rate of a touch input instrument, and the like. A touch is a gesture enables a user to put a touch input instrument in contact with a point of the touch panel 131 of a screen, a multi-touch is a gesture that enables a plurality of touch input instruments (for example, a thumb and an index finger) to be in contact with many points, a tap is a gesture that provides a touch input instrument on a point of a screen and removes the touch (touch-off) from the corresponding point, a double-tap is a gesture that touches a single point successively two times, a long tap is a gesture that touches a point relatively longer than tapping and removes the touch of a touch input instrument without a movement of the touch input instrument, a tap-and-touch is a gesture that taps a point on a screen and touches the point again within a predetermined time (for example, 0.5 seconds), a drag is a gesture that touches a point with a touch input instrument and moves the touch input instrument in a predetermined direction, a flick is a gesture that moves relatively quicker than dragging and removes the touch, a press is a gesture that touches a point, maintains the touch at least a predetermined time (for example, 2 seconds) without movement, a pinch-in is a gesture that simultaneously multi-touches two points with two touch input instruments and reduces an interval between the touch input instruments, and a pinch-out is a gesture that simultaneously multi-touches two points with two touch input instruments and increases an interval between the touch input instruments. That is, the touch refers to a contact with the touch panel 131, and other gestures refer to a change of a touch.

In the present disclosure, when a screen is set to bisection screens, the touch panel 131 senses a gesture for switching icons of the screen based on a reference line. Here, the gesture may be provided in the outside direction or in the inside direction from the outside. Also, according to another aspect, when a screen is set to quadrant screens, the touch panel 131 may sense a gesture for rotating icons on a screen about a reference point. Here, the gesture may be made in the lower direction from the upper portion, in the upper direction from the lower portion, in the right side from the left side, and in the left side from the right side.

In the present disclosure, the display panel 132 may display icons on a screen. Also, the display panel 132 may reposition icons based on a user's request, by switching icons on the left and icons on the right or rotating the icons. Also, the display panel 132 may display a soft key corresponding to a hard key within the reach of a finger, based on a hand of a user that is sensed by the touch panel 131.

The storage unit 140 may include a sub-memory. The sub-memory may be formed of a disk, a Random Access Memory (RAM), a Read Only Memory (ROM), a flash memory, or the like. The sub-memory may store a boot-up program, a plurality of virtual machines (that is, guest operation systems), a virtual machine monitor (that is, a host operation system), and a plurality of applications. The plurality of virtual machines operate based on a virtual machine monitor. Each of the plurality of virtual machines may act as an interface between hardware and an application or an interface between applications, and manages computer resources such as a CPU, GPU, a main memory, a sub-memory, and the like. The applications are classified into an embedded application and a third party application. For example, the embedded application includes a Web browser, an E-mail program, an instant messenger and the like. When power of a battery is supplied to the controller 110 of the portable terminal 100, a boot-up program may be loaded to a main memory of the controller 110. The boot-up program may load the host and guest operation systems to the main memory. The operation systems may load an application to the main memory. Loading is the known technology and thus, detailed descriptions will be omitted.

In the present disclosure, the storage unit 140 may store a method of repositioning icons of a screen and icon position information of an original screen before the icons are repositioned. Also, the storage unit 140 may store a method of switching icons based on a reference line of a screen. Also, the storage unit 140 may store a method of rotating icons about a reference point of a menu screen.

The sensor unit 150 may sense information associated with a location, a movement speed, a direction of movement, and rotation of the portable terminal 100. The sensor unit 150 may transfer, to the controller 110, sensed information based on a control of the controller 110. To this end, the sensor unit 150 may include an acceleration sensor or the like. That is, the sensor unit 150 coverts a sensed physical quantity into an electric signal, Analog-to-Digital (AD) converts the electric signal into data, and transfers the same to the controller 110. When the portable terminal 100 rotates, the sensor unit 150 may transfer the data associated with the rotation to the controller 110. Then, the controller 110 senses the rotation of the portable terminal 100, and changes a display mode of the screen in response to the sensing. Accordingly, the sensor unit 150 may sense a hand of a user that holds the portable terminal 100, and transfers information associated with sensing to the controller 110, based on a control of the controller 110.

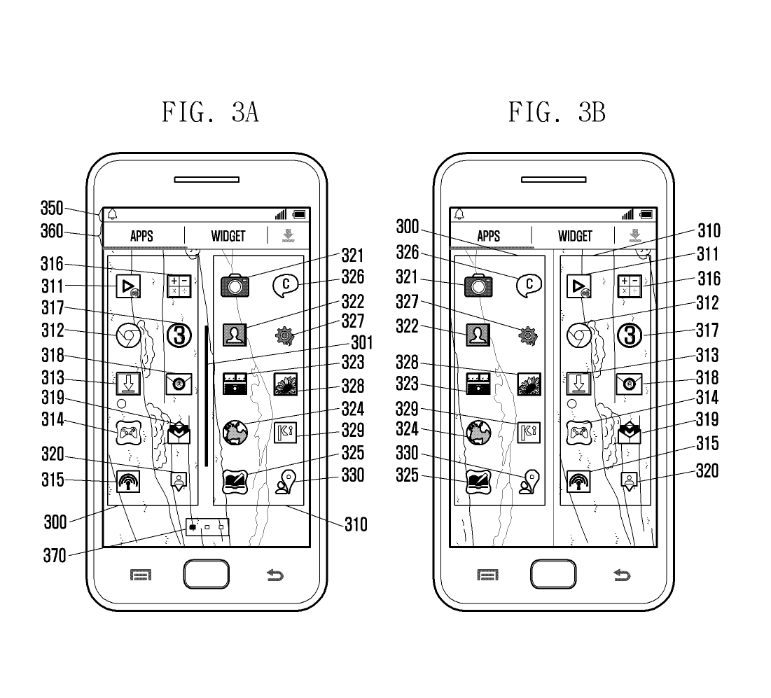

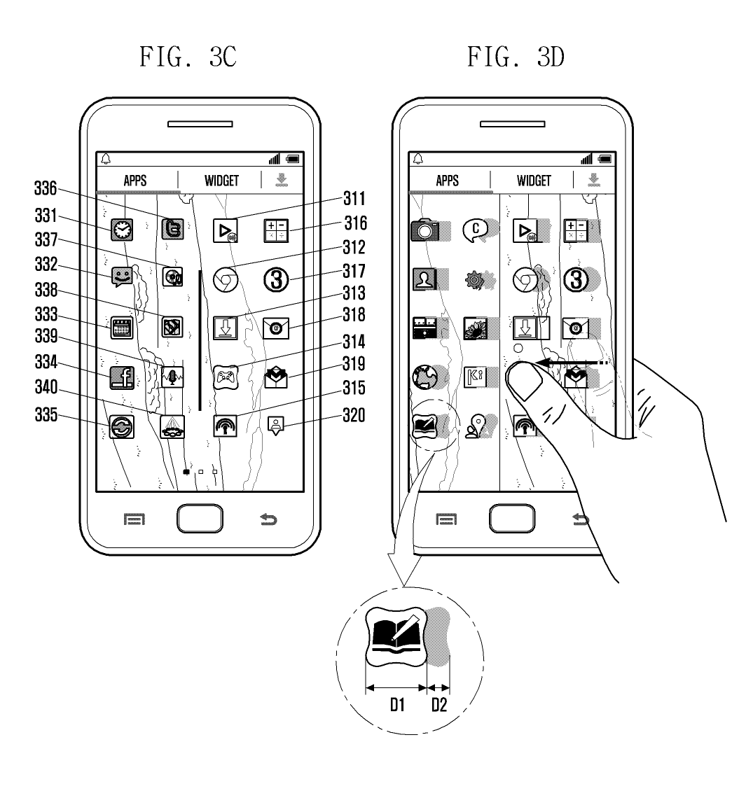

FIG. 2 is a flowchart of an example of a process for repositioning of visual items, according to aspects of the disclosure. FIGS. 3A-D are diagrams illustrating an example of the operation of the process, according to aspects of the disclosure. Although in this example, the visual items include icons, in other implementations, the visual items may include text links, text, image, thumbnail and/or any other usable type of visual item.

In operation 201, the display panel 132 may display icons. For example, the screen may be a screen that is divided into two sections, and/or any other suitable number of sections. The number of sections into which the screen is divided may be set by the user of the terminal 100 and/or the manufacturer of the terminal 100. In each section, icons corresponding to applications are displayed in a grid. For example, the screen of FIG. 3A is a menu screen including icons 311 through 330 which are displayed in a grid. The grid may be divided into a left area 300 and a right area 310 relative to a reference line 301. That is, the controller 110 may divide the menu screen into two sections screens for display. The controller 110 may control the display panel 132 to display or to not display the reference line 301 for dividing a screen. In the menu screen, the controller 110 may control the display panel 132 to display the icons 311 through 320 in the left area 300, and to display the icons 321 through 330 in the right area 310. The controller 110 may further display, in the menu screen, a notification bar 350, a widget 360, and a page indicator 370.

In operation 203 of FIG. 2, the controller 110 may detect a first gesture through the touch panel 131. That is, the touch panel 131 may detect the first gesture and transfer the detected first gesture to the controller 110, under a control of the controller 110. The first gesture may be a user gesture sensed by the touch panel 131, and may correspond to a drag, a touch, a multi-touch, a flick, a tap, and the like, and may not be limited thereto.

In operation 205, the controller 110 may determine whether the received first gesture is a gesture for swapping the positions of the icons displayed in the left area 300 and the right area 310. The gesture may be performed by a user who holds the portable terminal 100 with one hand, and provides an input on the touch panel 131 with the thumb of the hand that holds the portable terminal 100. A direction of a gesture input may be to the outside direction from the center of the touch panel 131 or to the inside direction toward the center from the outside. When the received first gesture is a gesture for swapping the positions of the icon groups displayed in the left area 300 and the right area 310, the process proceeds to operation 207. Otherwise, when the received first gesture is not a gesture for swapping the positions of the icon groups displayed in the left area 300 and the right area 310, the process proceeds to operation 215.

In operation 207, the controller 110 may swap the positions of the icon groups displayed in the left area 300 and the right 310. For example, the controller may move the group of icons displayed in the right area 310 from the right side to the left side of the reference line 301. Similarly, the controller may move the icons displayed in the left area 300 to the right area 310. (E.g., see FIGS. 3A-B.)

In some aspects, the swapping of the icon group's position may be performed by displaying a revolving door animation. That is, the revolving door is an example of a displaying UI when swapping the icons. According to this animation, when the gesture for swapping positions of the icons displayed in the left area 300 and the right area 310 is performed, the icons groups may shift to the right, such that the group in the left area 300 displayed in the right area 310 disappears in the right edge of the screen and reappears from the screen's left side.

In operation 215, the controller 110 may determine whether the first gesture is a gesture for shifting the icons. For example, shifting the icons may include moving a first one of the icon groups displayed in the left area 300 and the right area 310 over to the other side of the reference line 301, hiding the other one of the icon groups, and displaying a third group of icons at the position on the screen previously occupied by the first group of icons. In some aspects, shifting the icons may move one of the icon groups to an area of the screen of the terminal 100 that is more easily within reach of the user.

In operation 217, the controller 110 may shift icons on a background menu, in the manner illustrated by FIG. 3C. For example, the controller 110 may move the group of icons displayed in the left area 300 to the right area 310 and display a new group including icons 331-340 in the left area 300. The icons 331-340 may be hidden from display prior to the first gesture.

In operation 209 of FIG. 2, the controller 110 may detect a second gesture through the touch panel 131. That is, the touch panel 131 may detect the second gesture and transfer the detected second gesture to the controller 110, under a control of the controller 110. Accordingly, the controller 110 may detect the transferred second gesture. The second gesture may be a user gesture sensed by the touch panel 131, and may correspond to a drag, a touch, a multi-touch, a flick, a tap, and the like, and may not be limited thereto.

In operation 211, the controller 110 may determine whether the received second gesture is a gesture for returning the icons to their original locations. The icon reset motion is a motion for returning the icons 311 through 330 of FIG. 3A to their original locations as shown in FIG. 3A from the state in which the icons were left after the first gesture was received. When the second gesture is a gesture for returning the icons to their original locations, the process proceeds to operation 213. Otherwise, the process ends.

Referring to a screen of FIG. 3D, the controller 110 may detect a reset gesture in the state in which icons on the left and icons on the right are switched relative to the reference line 301. The reset gesture may be a gesture of dragging an icon by a length D2 that is shorter than the icon's length D1. The reset gesture may have any suitable direction, such as left-to-right, right-to-left, etc. When the length by which an icon is dragged is longer than the length of the icon, the controller 110 may treat the dragging gesture as a command to shift or swap the icons in the manner discussed above.

In operation 213 of FIG. 2, the controller may return the icons to the locations they were displayed at prior to the receipt of the first gesture. That is, the controller 110 may control the display panel 132 to display the icons 311 through 320 in the left area 300, and to display the icons 321 through 330 in the right area 310. Accordingly, the controller 110 may control the display panel 132 so as to display the icons 311 through 330 in their original locations.

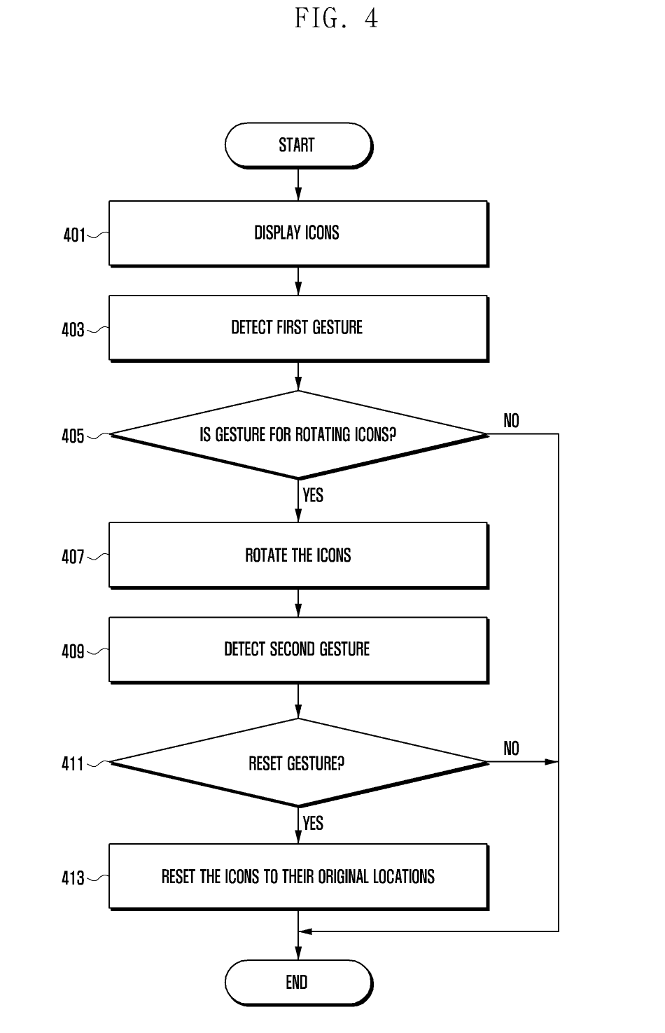

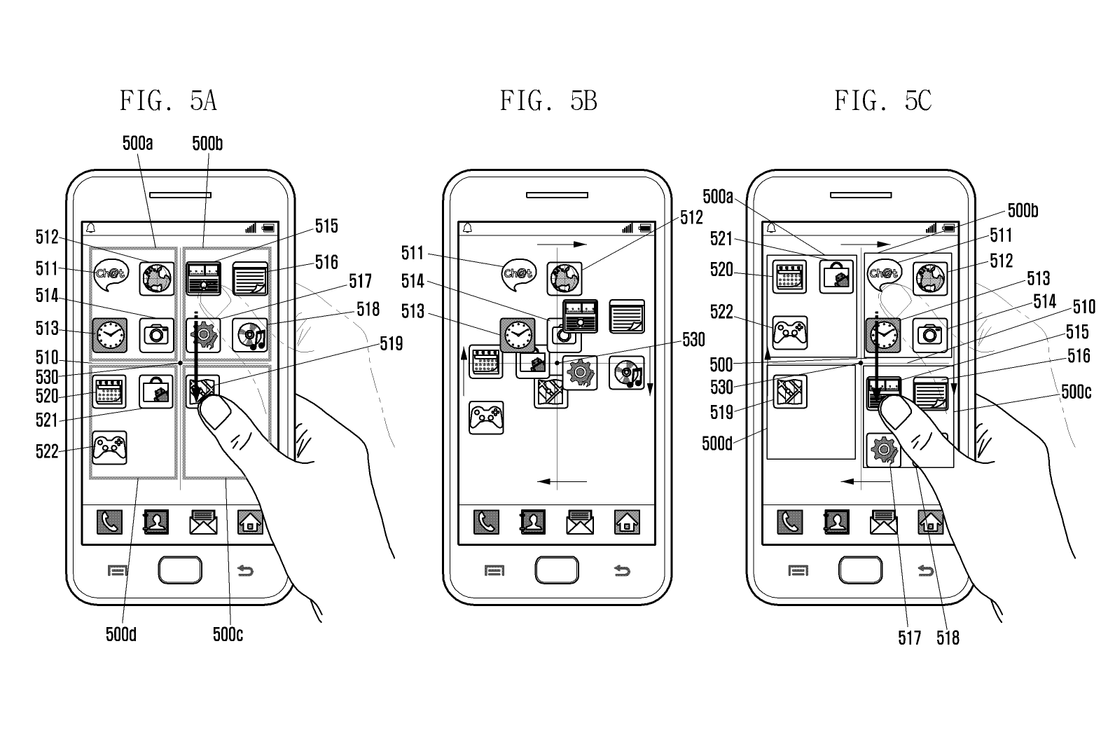

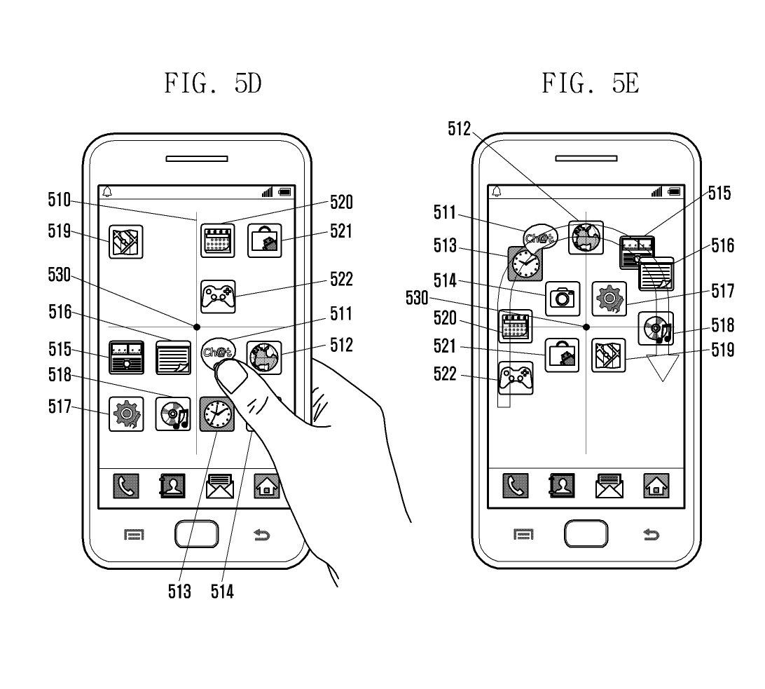

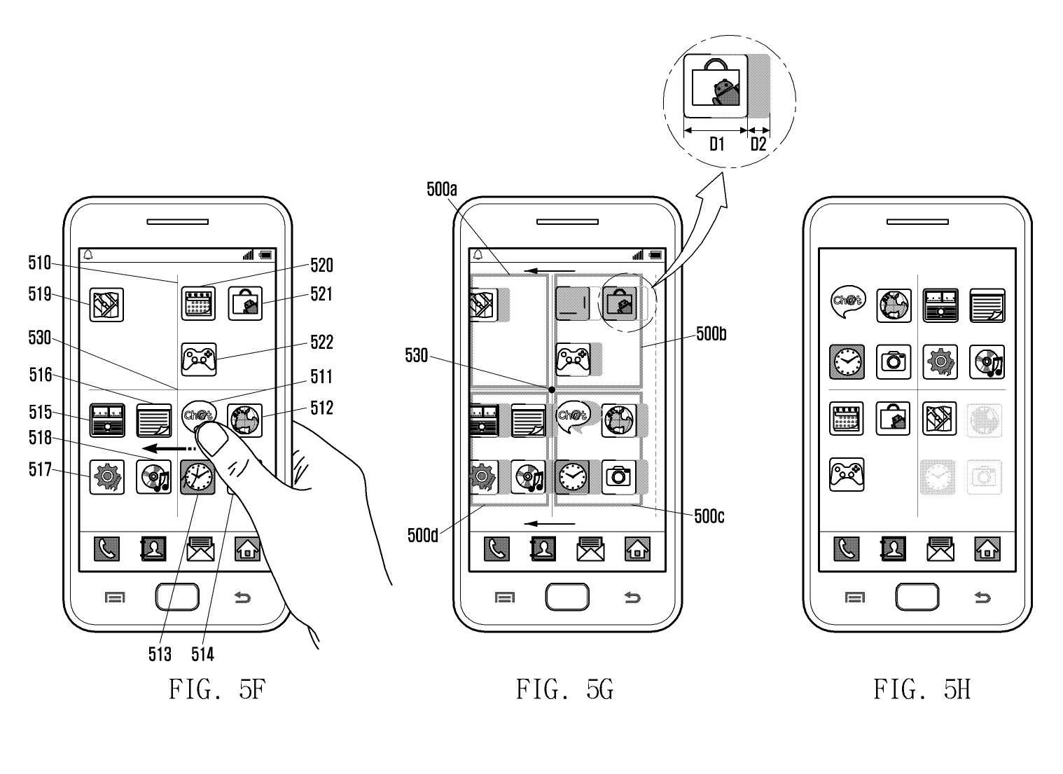

FIG. 4 is a flowchart of another example of a process for repositioning of visual items, according to aspects of the disclosure. FIGS. 5A through 5H are diagrams illustrating an example of the process, according to aspects of the present disclosure. Although in this example, the visual items include icons, in other implementations, the visual items may include text links, text, image, thumbnail and/or any other usable type of visual item. In operation 401, the display panel 132 may display icons on a screen based on a control of the controller 110. For example, the screen on which the icons are displayed may be a screen that is divided into quadrant sections, as shown in FIG. 5A. The number of sections into which the screen is divided may be set by the user of the terminal 100 and/or the manufacturer of the terminal 100. The number of sections into which the screen is divided may be set by the user or set by the manufacturer. In this example, the controller 110 may control the display panel 132 to include the reference line 510, a reference point 530, or the like in the screen on which the icons are displayed.

In operation 403, the controller 110 may detect a first gesture through the touch panel 131. That is, the touch panel 131 may detect the first gesture and transfers the detected first gesture to the controller 110, under a control of the controller 110. The first gesture may be a user gesture sensed by the touch panel 131, and may correspond to a drag, a touch, a multi-touch, a flick, a tap, and the like, and may not be limited thereto.

In operation 405, the controller 110 may determine whether the received first gesture is a gesture for rotating the icons. In some instances, the first gesture may be performed by a user who holds the portable terminal 100 with one hand, and provides an input on the touch panel 131 with the thumb of the hand that holds the portable terminal 100. The first gesture may have any suitable direction and/or shape, such as top-to-bottom, bottom-to-top, etc. When it is determined that the first gesture is a gesture for rotating the icons, the process proceeds to operation 407. Otherwise, the process ends.

In operation 407, the controller 110 may display the icons 511 through 522 by rotating the icons. That is, in operation 407, the controller 110 may rotate the icons 511 through 521 about the reference point 530 (please refer to FIG. 5) for display. In this example, the direction of rotation of icons may rotate clockwise or counterclockwise. Also, the direction of rotation of icons may be determined based on a direction of movement of a gesture.

For example, the controller 110 may perform a control to rotate the icons 511 through 521 as shown in FIG. 5B. The controller 110 may perform a control to rotate the icons 511 through 521 about the reference point 530, along the detected direction of icon rotation gesture. That is, when a rotation gesture turning clockwise is detected in FIG. 5A, the controller 110 may move the icons 511 through 521 about the reference point 530 in a clockwise direction. As illustrated in FIG. 5B, the controller 110 may move icons 511 through 514 from the area 500a to the area 500b. Simultaneously, the controller 110 may move icons 515 through 518 from the area 500b to the area 500c. Simultaneously, the controller 110 may move an icon 519 from the area 500c to the area 500d. Simultaneously, the controller 110 may move icons 520 through 522 from area 500d to the area 500a. In this example, the controller 110 may perform a control to rotate icons about a reference point 530 in a direction of the detected gesture.

Furthermore, as illustrated in FIG. 5C, the controller 110 may detect an additional rotation gesture 500 while the icons are rotating. That is, when the additional rotation gesture 500 is detected, the controller 110 may further rotate the icons 511 through 521 based on the additional rotation gesture 500 as follows. For example, the controller 110 may further move the icons 520 through 522 to the area 500b. Simultaneously, the controller 110 may further move the icons 511 through 514 to the area 500c. Simultaneously, the controller 110 may further move the icons 515 through 518 to the area 500d. Simultaneously, the controller 110 may further move the icon 519 in the area 500d to the area 500a. In this example, the controller 110 may to rotate icons about the reference point 530, in the direction of the detected gesture. FIG. 5D depicts a screen that displays the icons after the rotation in response to the additional rotation gesture 500 is completed.

As another example, the controller 110 may perform a control to rotate the icons 511 through 521 as shown in FIG. 5E. The touch panel 131 may detect a direction and a length of a rotation gesture and may transfer the same to the controller 110. The controller 110 may perform a control to rotate the icons 511 through 521 about the reference point 530, according to the direction and the length of the received rotation gesture. That is, when the rotation gesture 500 turning clockwise is detected in FIG. 5A, the controller 110 may move the icons 511 through 521 about the reference point 530 as illustrated. Thus, in the example of FIG. 5E, the degrees by which each group of icons is rotated about the reference point 530 may be based on at least one of the direction and/or length of the received gesture. This is in contrast to the examples of FIGS. 5B and 5C where the icon groups are rotated by 90° in response to each rotation gesture.

Returning again to the description of FIG. 4, in operation 409, the controller 110 may detect a second gesture through the touch panel 131. That is, the touch panel 131 may detect the second gesture and transfer the detected second gesture to the controller 110, under a control of the controller 110. The second gesture may be a user gesture sensed by the touch panel 131, and may correspond to a drag, a touch, a multi-touch, a flick, a tap, and the like, and may not be limited thereto.

FIG. 5F depicts a screen in which the controller 110 detects a second gesture. In operation 411, the controller 110 may determine whether the received second gesture is a gesture for resetting the locations of the icons to their original locations. The icon reset gesture is a gesture that returns the icons 511 through 522 to the location occupied by them prior to the receipt of the first gesture. As illustrated in FIG. 5G, the reset gesture may be a gesture that drags an icon by a length D2 that is shorter than the icon's length D1. The reset gesture may have a left-to-right, right-to-left, and/or any other suitable type of direction.

In operation 413 of FIG. 4, when the second gesture detected by the controller 110 is the reset motion for returning the icons to their original locations, the controller 110 returns the icons 511 through 522 to their original locations (e.g., the locations shown in FIGS. 5A and 5H). For example, the controller 110 may move the icon 519 back to the area 500c, in response to the second gesture. Simultaneously, the controller 110 may move the icons 520 through 522 back to the area 500d. Simultaneously, the controller 110 may move the icons 511 through 514 back to the area 500a. Simultaneously, the controller 110 may perform a control to move the icons 515 through 518 back to the area 500b.

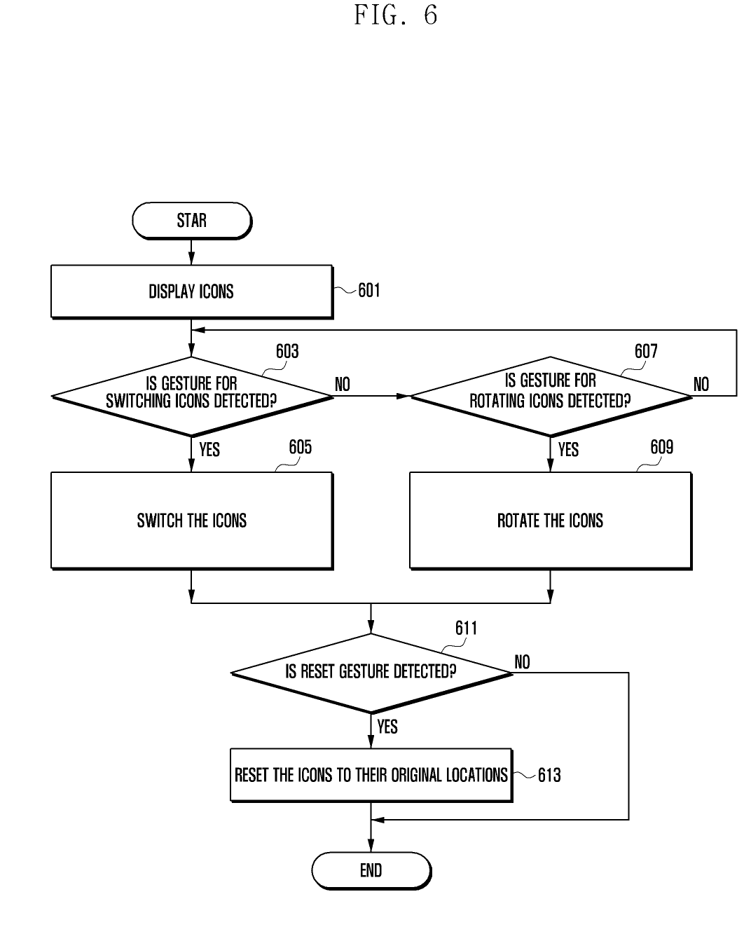

FIG. 6 is a flowchart of yet another example of a process for repositioning of visual items, according to aspects of the disclosure. Although in this example, the visual items include icons, in other implementations, the visual items may include text links, text, image, thumbnail and/or any other usable type of visual item.

In operation 601, the display panel 132 may display icons on a screen based on a control of the controller 110. For example, the screen on which icons are displayed may be divided into two or more sections.

In operation 603, the controller 110 may determine whether a gesture for switching icons on the left and icons on the right is detected through the touch panel 131. The touch panel 131 may detect the left and right icon switching gesture, and transfer the same to the controller 110. When it is determined that the received gesture is the left and right icon switching gesture, the process proceeds to operation 605. Otherwise, the process proceeds to operation 607.

In operation 605, the controller 110 may move the icons 311 through 320 from the left side of the reference line 301 to the right sight of the reference line 301, as shown in FIGS. 3A-C. Furthermore, the controller may move the icons 321 through 330 from the left side of the reference line 301 to the right sight of the reference line 301, as shown in FIGS. 3A-C.

In operation 607, the controller 110 may determine whether a gesture for rotating icons is detected through the touch panel 131, in operation 607. The touch panel 131 may detect the icon rotation gesture, and transfer the same to the controller 110. When it is determined that the received gesture is the left and right icon switching gesture, the process proceeds to operation 609. Otherwise, the process returns to operation 603.

In operation 609, the controller 110 may control the display panel 132 to rotate the icons 511 through 530 about the reference point 530, as shown in FIGS. 5A-D.

In operation 611, the controller 110 may determine whether a reset gesture is detected. When the reset gesture is detected, the process proceeds to operation 613. Otherwise, the process ends.

In operation 613, the controller 110 may reset the icons to their original locations and to display the same, in operation 613.

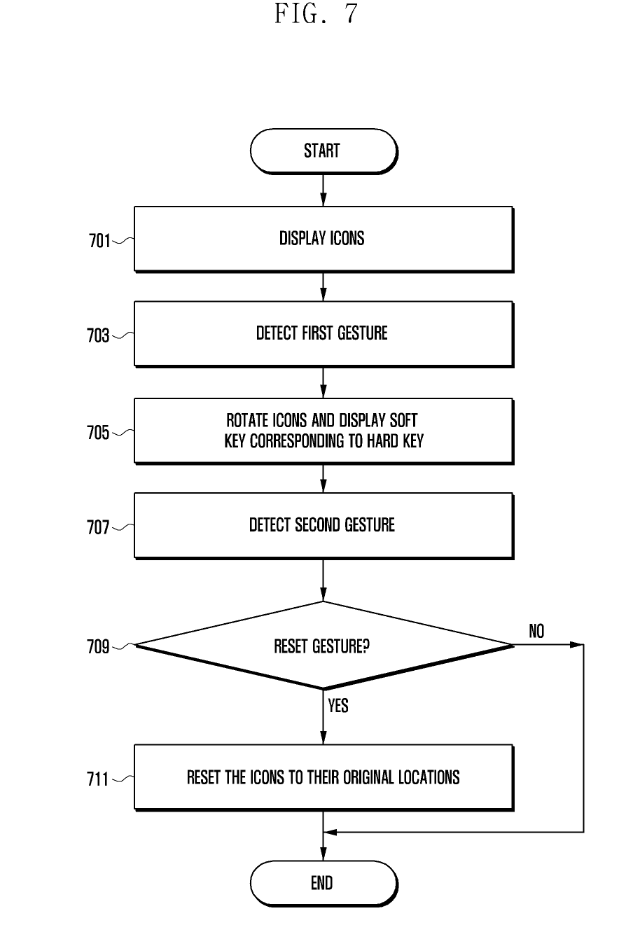

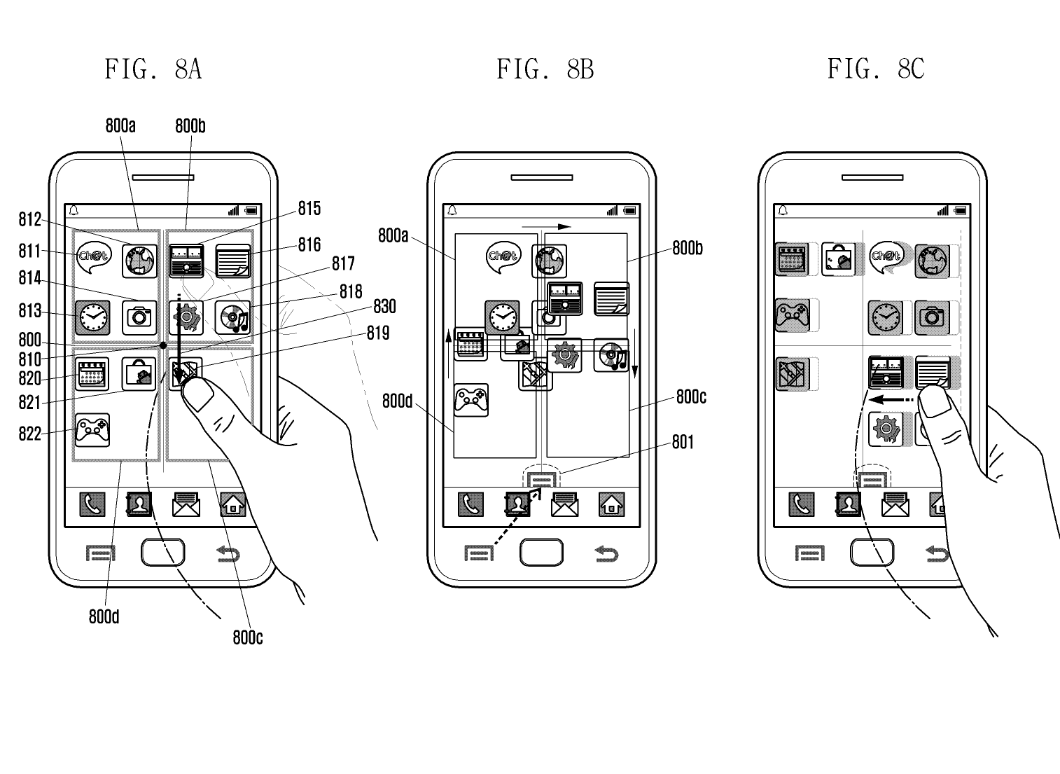

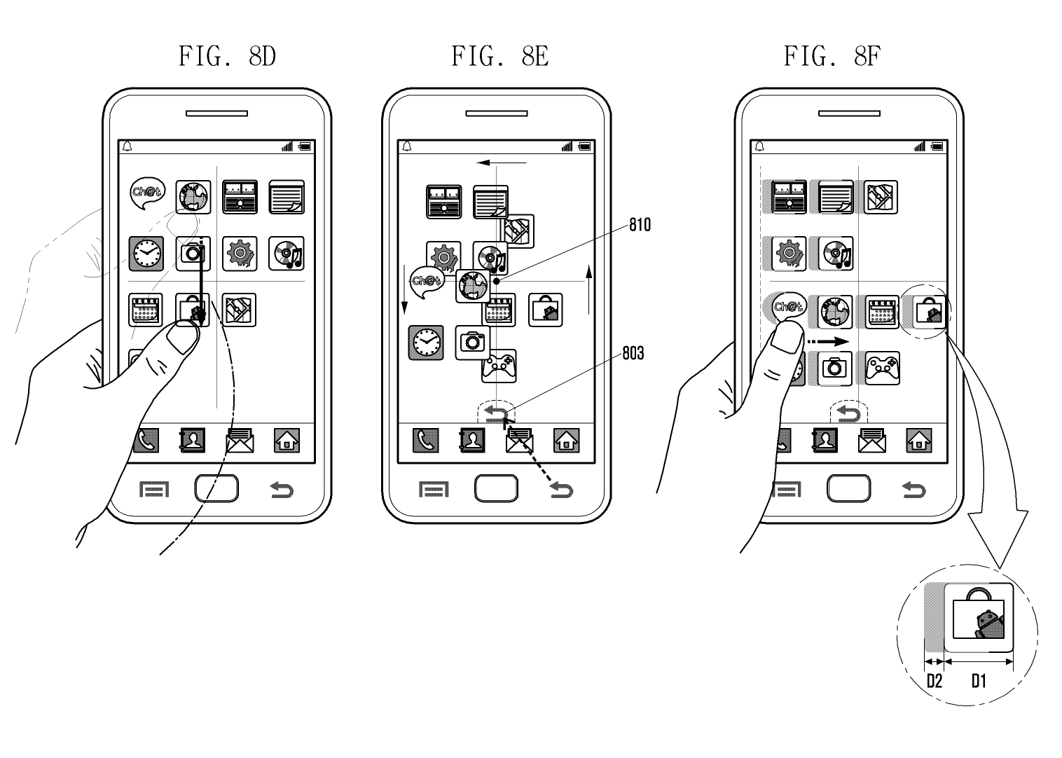

FIG. 7 is a flowchart of yet another example of a process for repositioning of visual items, according to aspects of the disclosure. FIGS. 8A through 8F are diagrams illustrating an example of the operation of the process, according to aspects of the disclosure. Although in this example, the visual items include icons, in other implementations, the visual items may include text links, text, image, thumbnail and/or any other usable type of visual item.

In operation 701, the display panel 132 may display icons 811 through 822 on a screen based on a control of the controller 110. For example, the screen may be a screen in which icons corresponding to applications are arranged in a grid of 4 rows and 4 columns. The screen may include two reference lines 800. Also, the menu screen may include a reference point 810 where the two reference lines 800 intersect.

In operation 703, the controller 110 may detect a first gesture through the touch panel 131. The first gesture may be a user gesture sensed by the touch panel 131, and may correspond to a drag, a touch, a multi-touch, a flick, a tap, and the like, and may not be limited thereto.

In operation 705, the controller 110 detects whether a hand of a user that holds the portable terminal 100 is the right hand or the left hand by using the sensor unit 150. For example, the controller 110 may detect the first gesture from the menu screen as shown in the screen of FIG. 8A while also detecting that the hand that holds the portable terminal 100 is the right hand. In FIG. 8A, the controller 110 may detect a first gesture 830. In this example, the first gesture 830 has a clockwise direction.

After detecting the first gesture, the controller 110 may rotate the icons displayed in the menu screen while also displaying at least one of a soft key 801 and a soft key 803 corresponding to different hard keys. The hard keys corresponding to the soft keys 801 and 803 may be relatively distant from the hand of the user that holds the portable terminal 100. That is, the soft key 801 and 803 corresponding to the hard key may be a key that is out of reach of a finger. Thus, in some aspects, the user may perform a sliding gesture (or any other type of input) to cause soft keys corresponding to hard keys of the terminal 100 to move closer to the user's thumb (or another finger.) In some implementations, each of the hard keys may be a key that is implemented using a switch or another sensor that is not part of the display panel of the terminal 100. For example, each of the hard keys may include a mechanical switch, an optical switch, a capacitive switch, etc.

For example, the soft key 801, when activated, may perform the same function as a menu key which is a hard key located in the lower portion of the left side. The controller 110 may perform a control to reposition the menu key that is out of reach of the thumb of the right hand to be within the reach of the thumb. Referring to FIG. 8B, the controller 110 may move icons 811 through 814 from an area 800a to an area 800b. Simultaneously, the controller 110 may move icons 815 through 818 from the area 800b to an area 800c. Simultaneously, the controller 110 may move an icon 819 from the area 800c to an area 800d. Simultaneously, the controller 110 may move an icon in the area 800d to the area 800a. In particular, as illustrated by FIG. 8C, the controller 110 may rotate the icons 811 through 822 around the reference point 810, and simultaneously display the soft key 801 corresponding to the hard key on the display panel 132.

Also, the controller 110 may detect a first gesture from a menu screen as shown in the screen of FIG. 8D. The controller 110 may detect a hand that holds the portable terminal 100 through the sensor unit 150. For example, the sensor unit 150 may determine which side of the portable terminal 100 is gripped through the grip sensor. Here, the controller 110 may detect that the hand that holds the portable terminal 100 is the left hand. After detecting the first gesture, the controller 110 may perform a control to rotate icons, and to display the soft key 803 corresponding to the hard key on the display panel 132. Here, the soft key 803 corresponding to the hard key is a back key placed in the lower portion of the right side. The controller 110 may perform a control to reposition the back key that is out of reach of the thumb of the left hand to be within the reach of the thumb. Accordingly, the controller 110 may control the display panel 132 to display the soft key 803 which performs the same function as the back hard key that is shown in the screen of FIG. 8E. In other words, the controller 110 may rotate the icons about the reference point 810 in the menu screen, when the first gesture is detected. Simultaneously, the controller 110 may perform a control to display the soft key 803 corresponding to the hard key within the reach of a finger.

In operation 707, the controller 110 may detect a second gesture. The controller 110 may detect the second gesture as shown in the screen of FIG. 8C and the screen of FIG. 8F.

In operation 709, the controller 110 may determine whether the detected second gesture is a reset gesture that repositions icons to their original locations. The reset gesture is a gesture that drags an icon, and a length D2 that the icon is dragged is shorter than a length D1 that the icon occupies. In operation 711, the controller 110 may control the display panel 132 to display the rotated icons in their original locations. Also, the controller 110 may control the display panel 132 to terminate the display of the soft key 801 and 803.

It is to be understood that the Figures are provided as an example only. At least some of the operations described in the Figures may be performed in a different order, performed concurrently, or altogether omitted. Although the examples provided in the present disclosure are described in the context of a portable terminal, it is to be understood that the techniques disclosed herein can be applied to any type of computing device, including, but not limited to, desktop computers, appliance controllers, etc.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions steps, and operations provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Unless otherwise stated, the examples presented herein are not mutually exclusive, but may be implemented in various combinations to achieve unique advantages. As these and other variations and combinations of the features discussed above can be utilized without departing from the disclosed subject matter as defined by the claims, the foregoing description of the embodiments should be taken by way of illustration rather than by way of limitation of the invention as defined by the claims. It will also be understood that the provision of examples (or aspects) of the invention (as well as clauses phrased as “such as,” “including,” “may,” “for example,” and the like) should not be interpreted as limiting the invention to the specific examples; rather, the examples are intended to illustrate only one of many possible embodiments.

It should be understood by those skilled in the art that many variations and modifications of the method and apparatus described herein will still fall within the spirit and scope of the present disclosure as defined in the appended claims and their equivalents.

What is claimed is:

1. A method for operating an electronic device comprising:
displaying a plurality of visual items on a screen of the electronic device;
detecting a first gesture received at the electronic device;
detecting whether the first gesture corresponds to a request for repositioning the plurality of visual items; and
when the first gesture corresponds to the request for repositioning the plurality of visual items, repositioning the plurality of visual items based on a direction of the first gesture.

2. The method of claim 1, wherein the plurality of visual items is organized into groups and repositioning the plurality of visual items includes rotating the groups about a predetermined reference point in the screen.

3. The method of claim 1, wherein:
displaying the plurality of visual items includes displaying a first set of one or more visual items from the plurality at a first location in the screen and displaying a second set of one or more visual items from the plurality at a second location in the screen; and
repositioning the visual items includes moving the first set of visual items to the second location and moving the second set of visual items to the first location.

4. The method of claim 3, wherein:
displaying the plurality of visual items includes displaying a first set of one or more visual items from the plurality at a first location in the screen and displaying a second set of one or more visual items from the plurality at a second location in the screen;
repositioning the visual items includes moving the first set of visual items to the second location, removing the second set of visual items, and displaying at the first location a third set of one or more visual items, the third set including visual items that are not displayed on the screen when the first gesture is detected.

5. The method of claim 1, wherein the electronic device includes a hard key which when activated causes the electronic device to perform a predetermined function, the method further comprising displaying a soft key corresponding to the hard key, wherein the soft key, when activated, also causes the electronic device to perform the predetermined function.

6. The method of claim 5, wherein the electronic device includes a sensor unit, and the soft key is displayed based on a signal from the sensor unit.

7. The method of claim 5, further comprising removing the soft key from display when a second gesture is detected.

8. The method of claim 1, further comprising, responsive to a second gesture, displaying the plurality of visual items in locations in the screen where the plurality of visual items are displayed prior to the first gesture being detected.

9. An electronic device, comprising:
a display panel;
a touch panel; and
a controller configured to:
display a plurality of visual items on the display panel;
detect a first gesture received at the touch panel;
detecting whether the first gesture corresponds to a request for repositioning the plurality of visual items; and
when the first gesture corresponds to the request for repositioning the plurality of visual items, repositioning the plurality of visual items based on a direction of the first gesture.

10. The electronic device of claim 9, wherein the plurality of visual items is organized into groups and repositioning the plurality of visual items includes rotating the groups about a predetermined reference point.

11. The electronic device of claim 9, wherein:
displaying the plurality of visual items includes displaying a first set of one or more visual items from the plurality at a first location in the display panel and displaying a second set of one or more visual items from the plurality at a second location in the display panel; and
repositioning the visual items includes moving the first set of visual items to the second location and moving the second set of visual items to the first location.

12. The electronic device of claim 10, wherein:
displaying the plurality of visual items includes displaying a first set of one or more visual items at a first location in the display panel and displaying a second set of one or more visual items from the plurality at a second location in the display panel; and
repositioning the visual items includes moving the first set of visual items to the second location, removing the second set of visual items, and displaying at the first location a third set of one or more visual items at the first location, the third set including visual items that are not displayed on the display panel when the first gesture is detected.

13. The electronic device of claim 9, further comprising a hard key which when activated causes the controller to perform a predetermined function, wherein the controller is further configured to display a soft key corresponding to the hard key, wherein the soft key, when activated, also causes the controller to perform the predetermined function.

14. The electronic device of claim 13, further comprising a sensor unit, wherein the soft key is displayed based on a signal from the sensor unit.

15. The electronic device of claim 13, wherein the controller is further configured to remove the soft key from display when a second gesture is detected.

16. The electronic device of claim 9, wherein, the controller is further configured to, responsive to a second gesture, display the plurality of visual items in locations in the display panel where the plurality of visual items are displayed prior to the first gesture being detected.

17. The method of claim 9, wherein the visual item includes icons.
